(19) United States
(12) Patent Application Publication
(10) Pub. No.: US 2026/0188811 A1
(43) Pub. Date: Jul. 2, 2026

(54) Jomode battery concept

(71) Applicant: Jomode Elie Getty, Jersey City, NJ (US)

(72) Inventor: Jomode Elie Getty, Jersey City, NJ (US)

(21) Appl. No.: 19/005,643

(22) Filed: Dec. 30, 2024

(51) Int. Cl. H01M 50/24; H01M 10/613; H01M 10/6563; H01M 50/204; H01M 50/503

(52) U.S. Cl. CPC H01M 50/24; H01M 10/613; H01M 10/6563; H01M 50/204; H01M 50/503

(57) ABSTRACT

A rechargeable battery system is disclosed comprising eight independent energy compartments arranged in a sequential operating cycle, each compartment provides approximately three hours of energy output. When one compartment is depleted, a subsequent compartment automatically begins operation, while the depleted compartment enters a rapid recharge phase, a full recharge of each compartment achieved in approximately ten minutes, sequential operation from compartment one through compartment eight enables continuous energy delivery for up to twenty-four hours, the system is configured for cyclic operation, allowing uninterrupted power output while previously used compartments undergo rapid recharging, when operated in a regular recharge schedule, the system provides extended continuous energy availability.

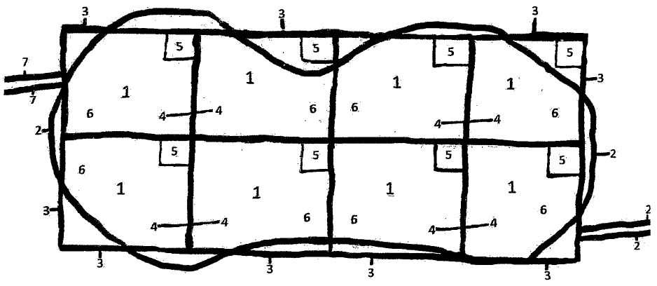

### BACKGROUND

The Rechargeable battery systems have enabled significant technological development since the mid-twentieth century, including aerospace applications, satellite systems, electric mobility, and) large-scale portable power. Batteries have become fundamental to storing and utilizing energy from both solar and conventional charging sources. Despite steady progress in electrochemical storage, most conventional rechargeable batteries operate as a single integrated unit, limiting continuous power availability during charging cycles. The present invention relates to a modular rechargeable battery system comprising eight internal energy compartments, each configured to operate independently and provide extended energy output. The system is capable of sequential operation in which one compartment supplies power while previously used compartments undergo rapid recharging. This configuration enables continuous energy availability without requiring external interruption in the discharge cycle.

### SUMMARY OF THE INVENTION

The invention provides a modular rechargeable battery system comprising eight internal energy compartments arranged to operate sequentially. Each compartment is configured to function autonomously and provide a defined period of energy output. When one compartment becomes depleted, a subsequent compartment automatically supplies power while the depleted compartment undergoes rapid recharging. Each compartment may reach full charge within a short recharge interval, enabling continuous or extended power delivery without interruption. The system supports cyclic operation in which power output and recharging occur simultaneously across different compartments. The modular configuration allows continuous energy availability and improved operational continuity compared to conventional single-unit rechargeable batteries. The invention may be integrated with a power generation system or used as a standalone energy storage device.

### DESCRIPTION OF THE DRAWING NUMBER 1

The drawing illustrates a modular battery power system enclosed within a protective rectangular housing. The internal structure is divided into interconnected battery compartments and auxiliary component spaces.
Battery units (1) store and deliver electrical energy.
Fast chargers (2) recharge the battery units from external sources.
Protective case (3) encloses and protects all components.
Cables (4) interconnect internal components for power and control.
Controllers (5) manage charging, discharging, safety, and balancing.
Fans (6) regulate internal airflow and temperature.
Output terminal (7) provides external electrical power.

1. A modular rechargeable battery system comprising:
Eight (8) rechargeable battery compartments arranged in sequence.
A fast-charging mechanism configured to fully recharge each compartment in approximately 10 minutes.
The four-dimensional sarcophagus enclosure fully containing the battery system, wherein the enclosure is: Fire-resistant and impervious, double-insulated to withstand extreme heat and cold conditions, equipped with eight (8) cooling fans and temperature control devices.
Eight (8) energy control units configured to manage the discharge and recharge cycles of each compartment.
A plurality of electrical cables interconnecting the battery compartments and connecting the system to external devices.

2. The system of claim 1, wherein the rechargeable battery is capable of supplying continuous power to external devices via the interconnecting cables.

3. The system of claims 1 and 2, wherein the system is configured to intermittently receive energy from an external fast-charging source while simultaneously providing energy output to connected devices.
